(19) United States
(12) Patent Application Publication
(10) Pub. No.: US 2013/0335090 A1
(43) Pub. Date: Dec. 19, 2013

(54) MILD STEEL DIPOLE ANTENNA SYSTEM FOR MEASURING OSCILLATORY ELECTRIC AND MAGNETIC FIELD STRENGTHS

(71) Applicant: Marius J. Mes, College Station, TX (US)

(72) Inventor: Marius J. Mes, College Station, TX (US)

(21) Appl. No.: 13/527,494

(22) Filed: Jun. 19, 2012

(51) Int. Cl. G01V 3/12

(52) U.S. Cl. 324/332

(57) ABSTRACT

A one dimensional dipole based antenna system is described used to measure oscillatory electric and magnetic field strengths and the rate of change of the magnetic field strength. The system relies on paramagnetic mild steel for selected dipole system components to decrease the sensitivity to high frequency oscillatory magnetic signals progressively above a certain frequency in the range of 300 to 10,000 Hz. The physical properties of the mild steel type used determine the actual frequency response characteristics. The antenna system, which can easily be expanded to a three dimensional system, is connected to an object (a survey platform) that is stationary or moving in an area of interest in air, over land, on water or under water. Such antenna system is generally used as part of a prospecting survey system for minerals or hydrocarbons.

### CROSS-REFERENCE TO RELATED APPLICATIONS

### Not Applicable

### STATEMENT REGARDING FEDERALLY SPONSORED RESEARCH OR DEVELOPMENT (IF APPLICABLE)

### Not Applicable

### REFERENCE TO SEQUENCE LISTING, A TABLE, OR A COMPUTER PROGRAM LISTING COMPACT DISC APPENDIX (IF APPLICABLE)

### Not Applicable

### BACKGROUND OF THE INVENTION

Diverse geophysical processes such as seismic and micro-seismic activity, volcanic activity, electric discharges from thunderstorms, vibrations introduced by human activities, and other phenomena generate propagating electromagnetic (EM) vibrations in the earth. The propagation and damping of these electric (E-type) and magnetic (B-type) emissions depend on the physical properties of the material in the earth. Differences in the local strength and phase characteristics of these electromagnetic vibrations can be used as indicators for the presence of hydrocarbons or minerals. These E-type and B-type oscillatory emissions always occur together. They can be measured separately by different sensing systems. My invention concerns a system to measure E-type and B-type signals as well as the rate of change of B-type signals with a high resolution at a rate of digitization in excess of 2000 Hz.

Moving survey platforms are used to collect such oscillatory electric signals using a three dimensional dipole antenna system. The survey platforms may consist of manned or unmanned aircraft, drones towed behind aircraft, drones suspended under helicopters, drones towed behind ships, ships, cars, trucks or a stationary object. Suitable electronic equipment is used to digitize and store these signals. The frequency of the signals of interest is in the order of 0.01 Hz to approximately 3,000 Hz depending on the mild steel used. This invention concerns the antenna sensor system used to collect the oscillatory electric and magnetic field strengths. A three dimensional antenna system consists of three independent dipole antenna systems that are mutually perpendicular. The antennas of a three dimensional system do not need to have a common point of intersection. The individual dipole antenna systems may be located anywhere on the survey platform. For moving survey platforms, one dipole antenna will generally point in the direction of motion while the other two may be tilted by up to 30 degrees in the direction of the air or water flow to reduce the antenna oscillations induced by the flow. Key to this invention is the use of paramagnetic mild steel for the dipole antenna legs. This allows the dipole legs to function to collect the oscillatory electric and magnetic field strengths while at the same time high frequency magnetic oscillations are automatically reduced or eliminated by the response characteristics of the mild steel to magnetic oscillations. The size of the dipole legs is controlled by practical requirements. An individual dipole leg can range from approximately 0.1 meter to several meters, as dictated by the survey requirements.

A description of prior art on which the currently used technology is based can be found in representative patents and patent applications. Examples of patents describing such technology are, for example: 1) U.S. Pat. No. 7,002,350, describes a three dimensional antenna system for a marine oil and gas exploration survey system, 2) U.S. Pat. No. 6,765,383 B1 describes a similar airborne system for drones, and 3) U.S. Pat. No. 4,945,310 describes a single dipole antenna system of a geophysical prospecting tool used to detect electromagnetic radiation. Such a system is not of concern for my invention.

### BRIEF SUMMARY OF THE INVENTION

This invention describes a single dipole antenna system used to measure oscillatory electric and magnetic field strengths used in certain survey systems to explore for the presence of commercial quantities of hydrocarbons and minerals. The system can easily be expanded to a three dimensional dipole antenna system. The antenna system is located on a survey platform. My invention is a response to the need to improve a system to measure E-type and B-type signals as well as the rate of change of B-type signals with a high resolution at a rate of digitization in excess of 2000 Hz.

This invention advances to the state of the art by introducing practical design improvements to a single set of dipole antennas by using mild steel for the antenna legs that improves the signal to noise ratio of the low frequency magnetic measurements by progressively dissipating higher frequencies.

### BRIEF DESCRIPTION OF THE SEVERAL VIEWS OF THE DRAWINGS

FIG. 1 illustrates our first development consisting of a full dipole antenna system with two antenna legs. A mild steel paramagnetic dipole rod antenna has two legs 1 and 2 with a small ground piece 3 in between. The length of the mild steel ground piece is not critical. It can vary over a broad range. In practice this range will be from 0.010 to 0.1 meters. Its diameter will at least be the diameter of the dipole legs. There is a small gap 6 and 7 between the ground piece and the antenna legs 1 and 2. The size of the gap can vary over a broad range. In practice this range will be from 0.010 to 0.1 meters. The diameter of the dipole legs and the ground piece can also vary over a broad range. In practice this will be from 0.003 to 0.02 meters. The length of the individual dipole legs varies with the survey conditions; they do not need to be equally long. In practice the dipole leg length will be from 0.1 to 3 meters. The antenna device is intended to sense electric signals by means of the mild steel antenna legs, the signals of these antennas are transported by wires 8 and 9 to electronic amplification and recording equipment while ground piece 3 serves as electronic ground reference. It is connected by wire 10 to the electronic amplification and recording equipment.

Variations in the magnetic field strengths are picked up by solenoids 4 and 5 placed around the mild steel rods 1 and 2. The solenoids are connected by wires 11 and 12 to electronic amplification and recording equipment. The ideal distance between the solenoids depends on the size of the gaps 6 and 7. It is best established by experimentation. It will generally be equal to a quarter of the total length of the dipole including the ground piece 3. The mild steel of the antenna legs causes the magnetic system to be insensitive to high frequency variations in the magnetic field strength. Typically noise has high frequencies and thus these frequencies are automatically reduced or filtered out in the measured signal. The solenoids 4 and 5 are provided with grounded electric shielding for protection against noise from electric field variations.

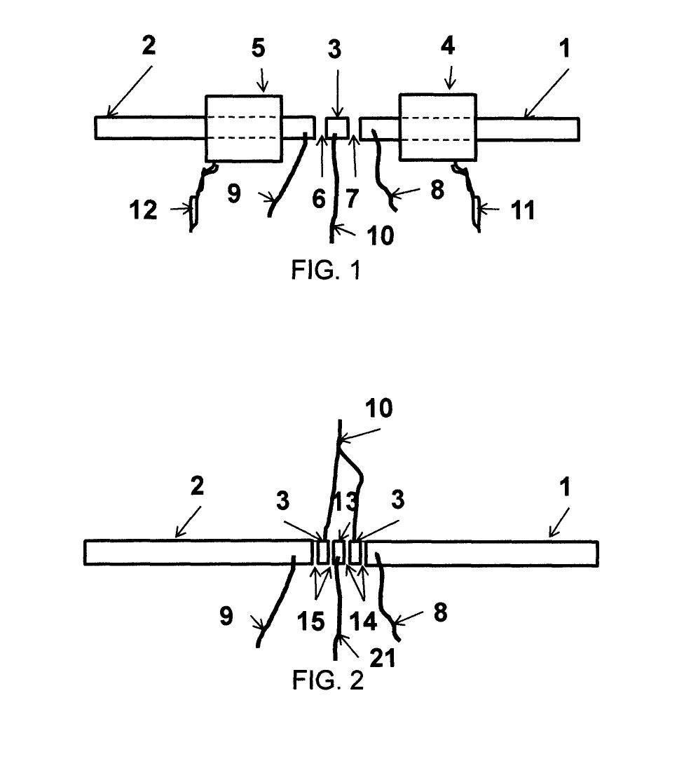

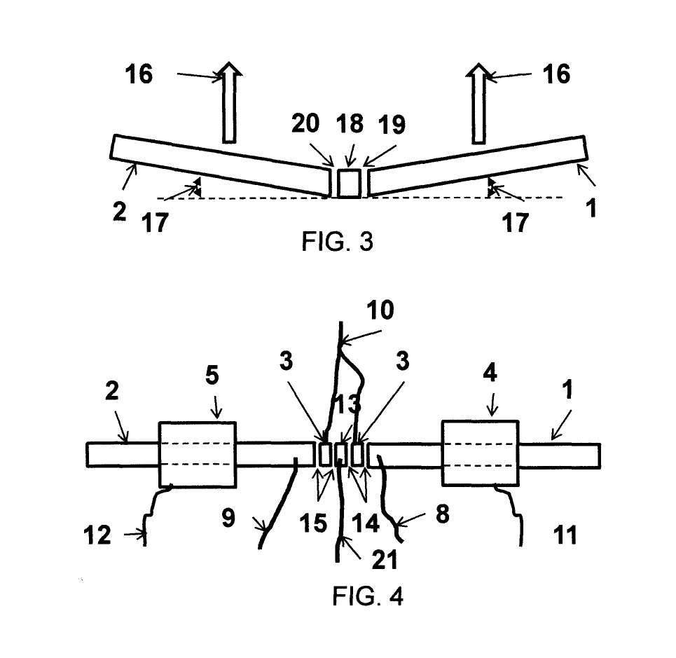

FIG. 2 illustrates another method to measure variations in magnetic field strength. As an alternative to solenoids, variations in the magnetic field strengths can be picked up by solid state devices 13 depicted in FIG. 2 such as, but not limited to, Hall-type sensors, magnetoresistive sensors, Metglass/PZT laminate sensors, etc., connected by wires 21 to electronic amplification and recording equipment. The ground piece 3 of FIG. 1 is split in two and the halves are placed on either side of the solid state sensor 13. The ground pieces connect with wires 10 to the electronic amplification and recording equipment. The gaps 14 and 15 are kept small such as, but not limited to, 0.0001 meter in order to keep the distance between the dipole legs 1 and 2 as small as practical.

FIG. 3 depicts the shape of the dipole antenna for the two out of three antenna systems of a three dimensional dipole antenna system that experience strong cross flows of air or water under normal survey conditions. To reduce or prevent mechanical vibrations in the dipole rods, the dipole antenna rods are installed at a slight angle 17 (such as, but not limited to thirty degrees). This angular deviation 17 is generally in the direction of air or water flow 16. In this case either the ends of the dipole antenna rods 1 and 2 or the facing ground piece (or ground pieces with a solid state device in between) 18 or both are shaped to maintain a small and uniform gap 19 and 20. FIG. 3 depicts the case where only the dipole legs are shaped.

FIG. 4 depicts the optimal dipole rod antenna design for measuring the magnetic field strength and its variations as well as the electric field strength in the frequency range of 0.01 to 10,000 Hz depending on the physical properties of the mild steel used. It consists of two mild steel paramagnetic dipole rod antenna legs 1 and 2 that are connected with wires 8 and 9 to the electronic amplification and recording equipment. Solenoids 4 and 5 placed on them are connected with wires 11 and 12 to the electronic amplification and recording equipment. Two paramagnetic mild steel ground pieces 3 straddle a solid state magnetic field strength sensor 13 that is connected with wire 21 to the electronic amplification and recording equipment. The solid state sensor may consist of many solid state sensors that are combined to increase the sensitivity and reduce the noise of the measurements. The ground pieces 3 connect with wires 10 to the electronic amplification and recording equipment. The gaps 14 and 15 are kept small such as, but not limited to, 0.0001 meters in order to keep the distance between the dipole legs 1 and 2 as small as practical.

Dipole antennas 1 and 2 as well as the ground piece(s) may be electrically insulated by some coating to prevent direct contact with the air or water around them. We found that the presence of a ground piece or ground pieces only marginally improves the performance of the dipole antenna system. We have omitted them for simplicity of construction in some cases. A numerical integration of the solenoid measurements is a control for the oscillatory magnetic measurement results of the solid state sensor system. If such a control is not necessary, either the solenoids or the solid state magnetic sensor(s) can be omitted in the antenna system.

### DETAILED DESCRIPTION OF THE INVENTION

Oscillatory electromagnetic field strength measurements are of interest to the mining and hydrocarbon industry for resource exploration purposes. This type of measurement requires three dimensional sensor systems for electric and magnetic field strength variations. The frequency range of interest generally is from 0.01 Hz to 10,000 Hz. The upper limit is of interest for some geophysical interpretation systems. A combination of magnetic and electric sensors is used to obtain the needed data. In this invention a solenoid and/or a solid state magnetic sensor is applied to record magnetic field strength variations at high rates of digitization as required by the data analysis. This invention addresses the reduction of high frequency noise in the measurements by applying mild steel in the shape of a dipole antenna rod as magnetic field strength concentrators. Mild steel is sensitive to magnetic field strength variations at low frequencies; its function as a magnetic field strength concentrator decreases progressively for frequencies above 300 to 10,000 Hz depending on the physical properties of the steel. This phenomenon is used to reduce the high frequency noise in the magnetic field strength measurements. This invention aims to reduce the influence of noise sources with a frequency above 300 to 10,000 Hz on magnetic field strength measurements.

The magnetic field concentrator doubles as electrical antenna. This simplifies the construction of electromagnetic sensor systems.

Conventional magnetic sensors used by the survey industry such as cesium vapor and flux gate sensors have limitations when their signals are sampled at speeds above 10 Hz respectively 100 Hz. This makes these sensors unsuitable for applications requiring the sampling of for example 3,000 Hz signals at 30,000 Hz. The use of a solenoid or a solid state magnetic sensor allows the sensor signals to be sampled and digitized at such a high rate.

It will be understood that the above-described embodiments of the invention are illustrative in nature, and that modifications thereof may occur and be made by those skilled in the art. Accordingly, this invention is not to be regarded as limited to the embodiments disclosed herein, but is to be limited only as defined in the appended claims.

1) A paramagnetic mild steel dipole antenna system equipped with sensors was invented to measure the magnetic oscillatory field strength, its rate of change and the electric field strength in air or under water for frequencies ranging from 0.01 Hz to up to 10,000 Hz where the upper limit for magnetic oscillatory field strength measurements depends on the type of paramagnetic mild steel used.

2) The dipole antenna system as in claim 1 in which the legs of the dipole antenna system rely on the physical properties of paramagnetic mild steel to progressively decrease the sensitivity of the dipole system to higher oscillatory magnetic frequencies which are considered as noise above a certain frequency which is usually in the range of 300 to 10,000 Hz for geophysical surveys.

3) A dipole antenna as in claim 1 in which the ground for each leg of the dipole antenna consists of two ground pieces of paramagnetic mild steel placed between the legs of the dipole antenna with only a small gap between them and the dipole antenna legs.

4) The ground pieces of paramagnetic mild steel as in claim 3 in which the ground pieces of paramagnetic mild steel are straddling a solid state magnetic field strength sensor leaving little or no gap between the sensor and the ground pieces.

5) The solid state magnetic field strength sensor as in claim 4 in which the sensor or sensing element may consist of many sensors or sensing elements to reduce the measurement noise and increase the sensitivity of the solid state magnetic sensor system.

6) A dipole antenna as in claim 1 in which the sensor for the rate of change of the magnetic field strength consists of one solenoid placed on each leg of the dipole antenna.

7) The solenoids as in claim 6 in which the optimal distance between the solenoids is to be determined by experimentation but generally is in the range between 0.1 to 0.5 times the distance of the extreme tips of the dipole antenna system.

8) A dipole antenna as in claim 1 in which the overall length of the dipole antenna system is approximately 0.1 to several meters as dictated by the practical survey requirements and limitations.

9) The ground pieces of paramagnetic mild steel as in claim 4 may have a slightly larger cross section than the bordering dipole antenna legs with a length in the dipole antenna axis ranging from 0.003 to 0.02 meters.

10)The two ground pieces of paramagnetic mild steel as in claim 3 may be combined into a single ground piece if no sensor is placed between them.
